(19) United States
(12) Patent Application Publication
(10) Pub. No.: US 2022/0005446 A1
(43) Pub. Date: Jan. 6, 2022

(54) SPEAKER AND MUSICAL INSTRUMENT CASE

(71) Applicant: YAMAHA CORPORATION, Hamamatsu-shi (JP)

(72) Inventor: Akihiko NOZAKI, Minato-ku (JP)

(21) Appl. No.: 17/447,930

(22) Filed: Sep. 16, 2021

Related U.S. Application Data
(63) Continuation of application No. PCT/JP2020/003113, filed on Jan. 29, 2020.

(30) Foreign Application Priority Data
Mar. 20, 2019 (JP) 2019-052388

(51) Int. Cl. G10G 7/00; H04R 7/06; H04R 1/02

(52) U.S. Cl. CPC G10G 7/005; H04R 17/10; H04R 1/025; H04R 7/06

(57) ABSTRACT

A speaker includes a first flat diaphragm, an actuator that applies vibration corresponding to a sound signal to the first flat diaphragm, and a second flat diaphragm separated from the first flat diaphragm and vibrated by the actuator.

This application is a continuation of U.S. Patent Application No. PCT/JP2020/003113 filed on Jan. 29, 2020, which claims priority benefit of Japanese Patent Application No. JP 2019-052388 filed in the Japan Patent Office on Mar. 20, 2019. Each of the above-referenced applications is hereby incorporated herein by reference in its entirety.

### BACKGROUND

The present disclosure relates to a speaker and a musical instrument case.

Examples of speakers include an actuator-driven speaker including an actuator that vibrates a flat diaphragm; and a dynamic speaker including a conical diaphragm. In the case of the actuator-driven speaker, the diaphragm is often used a highly-rigid and heavy body. Thus, there is a problem of difficulty in ensuring sound pressure across a usable band from a low frequency range to a high frequency range, including difficulty in ensuring the sound pressure particularly in a low tone range. On the other hand, in the dynamic speaker, a large-diameter speaker unit is necessary for a high-volume output, making the thickness of the speaker large. Thus, there is a problem that the dynamic speaker is not suitable for a product that requires transportability and portability. An example of a speaker that reinforces a low tone range includes a bass reflex speaker with a phase inversion enclosure (for example, see Japanese Patent Laid-Open No. 2008-48176).

### SUMMARY

A bass reflex port and an enclosure are necessary in the bass reflex speaker, and thus, the bass reflex speaker is not suitable for a product that needs to make a high output and that requires transportability and portability.

The present disclosure has been made in view of the problem, and it is desirable to provide a speaker that can ensure sound pressure across a usable band from a low frequency range to a high frequency range without affecting transportability and portability even when a high-volume output is necessary.

To solve the problem, the present disclosure provides a speaker including a first flat diaphragm; an actuator that applies vibration corresponding to a sound signal to the first flat diaphragm; and a second flat diaphragm separated from the first flat diaphragm and vibrated by the actuator.

In the speaker in a more preferable mode, an area of the first flat diaphragm is smaller than an area of the second flat diaphragm.

The speaker in a more preferable mode further includes an elastic body that connects the actuator and the second flat diaphragm.

In the speaker in a more preferable mode, the elastic body and the second flat diaphragm are integrally molded.

In the speaker in a more preferable mode, the first flat diaphragm and the second flat diaphragm are arranged to face each other.

In the speaker in a more preferable mode, the first flat diaphragm and the second flat diaphragm are arranged parallel to each other.

In the speaker in a more preferable mode, the first flat diaphragm and the second flat diaphragm are arranged on the same plane.

The speaker in a more preferable mode further includes an elastic member arranged between the first flat diaphragm and the actuator, in which the actuator applies the vibration to the first flat diaphragm through the elastic member.

In the speaker in a more preferable mode, the actuator applies, to the second flat diaphragm, vibration in a phase opposite of that of the vibration applied from the actuator to the first flat diaphragm.

In the speaker in a more preferable mode, the actuator has a shape including a first surface and a second surface, the first flat diaphragm is connected to the first surface of the actuator, and the second flat diaphragm is connected to the second surface of the actuator.

In the speaker in a more preferable mode, the elastic member is directly connected to the first surface of the actuator.

In the speaker in a more preferable mode, the elastic body is directly connected to the second surface of the actuator.

In the speaker in a more preferable mode, the second surface of the actuator is directly connected to the second flat diaphragm.

Furthermore, to solve the problem, the present disclosure provides a musical instrument case including a case main body that houses a musical instrument; a lid body; and the speaker according to any one of the modes, in which the lid body provides the second flat diaphragm.

### BRIEF DESCRIPTION OF THE DRAWINGS

FIG. 1 is a diagram illustrating a configuration example of a musical instrument case 1 according to an embodiment of the present disclosure;

FIG. 2 is a front view of a speaker 10A provided on a lid body 3 of the musical instrument case 1;

FIG. 3 is a rear view of the speaker 10A;

FIG. 4 is a cross-sectional view of the speaker 10A;

FIG. 5 is a diagram illustrating simulation results of frequency response of the speaker 10A;

FIG. 6 is a front view of a speaker 10B according to a second embodiment of the present disclosure;

FIG. 7 is a rear view of the speaker 10B according to the second embodiment of the present disclosure;

FIG. 8 is a cross-sectional view of the speaker 10B;

FIG. 9 is a front view of a speaker 10C according to a third embodiment of the present disclosure;

FIG. 10 is a rear view of the speaker 10C;

FIG. 11 is a cross-sectional view of the speaker 10C;

FIG. 12 is a front view of a speaker 10D in a modification example (2);

FIG. 13 is a rear view of the speaker 10D; and

FIG. 14 is a cross-sectional view of the speaker 10D.

### DETAILED DESCRIPTION OF THE PREFERRED EMBODIMENTS

Hereinafter, embodiments of the present disclosure will be described with reference to the drawings.

### A: First Embodiment

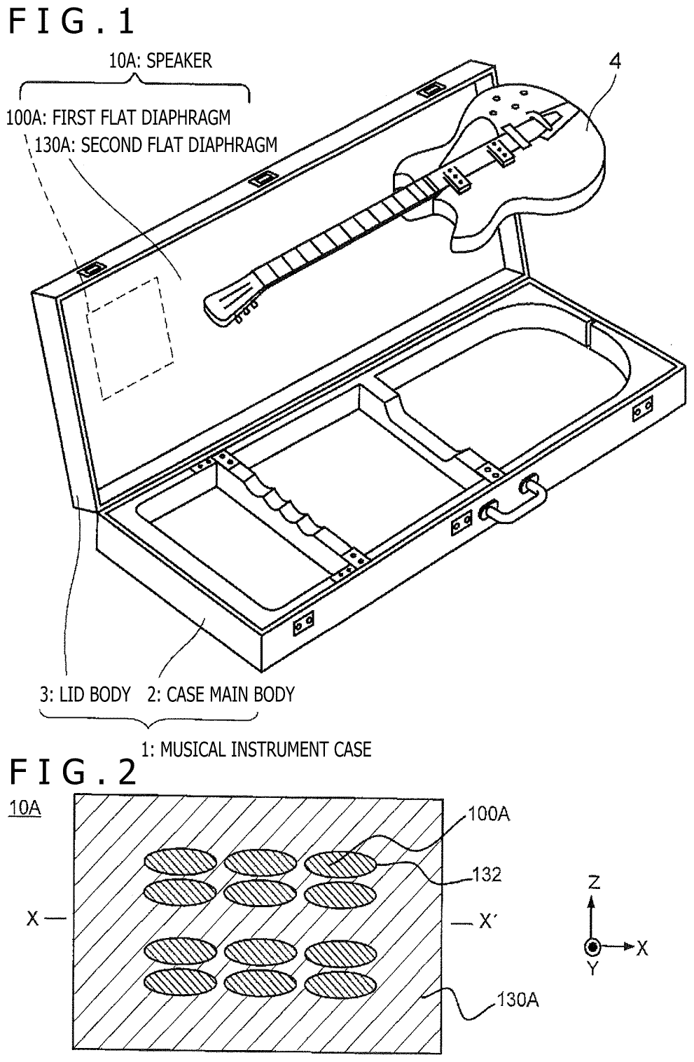

FIG. 1 is a diagram illustrating a configuration example of a musical instrument case 1 according to an embodiment of the present disclosure. The musical instrument case 1 illustrated in FIG. 1 is a musical instrument case for housing a musical instrument 4 such as a guitar, for example. As illustrated in FIG. 1, the musical instrument case 1 includes a case main body 2 for housing the musical instrument 4, a lid body 3 provided on the case main body 2 in a manner that the lid body 3 can be freely opened and closed, and a speaker 10A provided on the lid body 3. The musical instrument case 1 of the present embodiment is characterized in that the speaker 10A including a first flat diaphragm 100A and a second flat diaphragm 130A is provided on the lid body 3. Hereinafter, the speaker 10A will be mainly described.

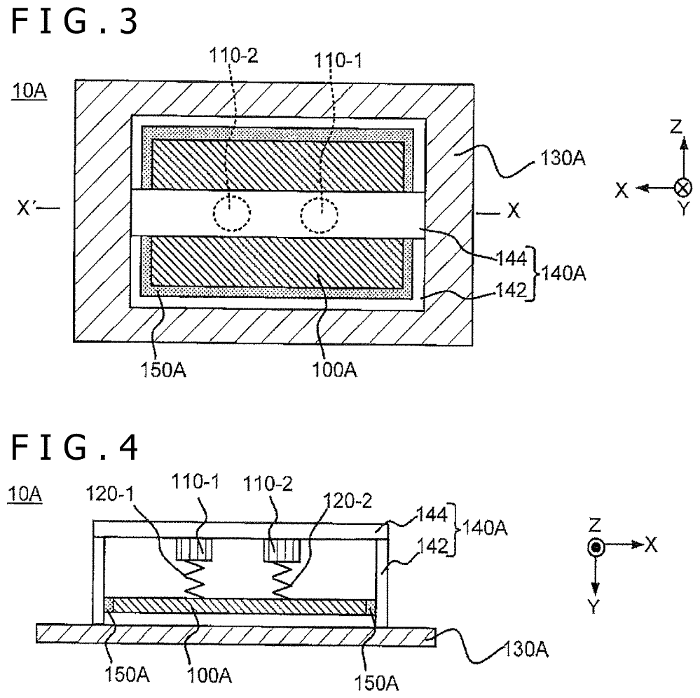

FIGS. 2 to 4 are diagrams illustrating a configuration example of the speaker 10A. More specifically, FIG. 2 is a front view of the speaker 10A, and FIG. 3 is a rear view of the speaker 10A. Further, FIG. 4 is a cross-sectional view of the speaker 10A in a plane along a line XX′ in FIGS. 2 and 3. As illustrated in FIGS. 2 to 4, the speaker 10A includes actuators 110-1 and 110-2, elastic members 120-1 and 120-2, a connection member 140A (an example of the elastic body), and an edge 150A, in addition to the first flat diaphragm 100A and the second flat diaphragm 130A.

The second flat diaphragm 130A includes the entire plane portion that faces the case main body 2 when the lid body 3 is closed. The second flat diaphragm 130A is made of resin, such as polystyrene, or metal, such as aluminum. The lid body 3 is bent at substantially right angles on four sides around the second flat diaphragm 130A, and the lid body 3 is formed such that tips of the parts bent at right angles when the lid body 3 is closed come into contact with the case main body 2. That is, the musical instrument case 1 of the present embodiment is characterized in that the lid body 3 provides the second flat diaphragm 130A of the speaker 10A. The first flat diaphragm 100A is also a member formed in a flat plate shape by resin, such as polystyrene, or metal, such as aluminum. The first flat diaphragm 100A is formed in a rectangular shape with an area smaller than the area of the second flat diaphragm 130A. In the speaker 10A of the present embodiment, the first flat diaphragm 100A is provided to face the second flat diaphragm 130A. As illustrated in FIG. 4, the first flat diaphragm 100A is arranged at a position parallel to the second flat diaphragm 130A and separated by a predetermined distance from the second flat diaphragm 130A in an axial direction of the actuator 110 described later. A plurality of openings 132 in a flat elliptical shape are provided on the part of the second flat diaphragm 130A facing the first flat diaphragm 100A. In the example illustrated in FIG. 2, twelve openings 132 in total, four in each line in a Z direction and three in each line in an X direction, are provided on the second flat diaphragm 130A in a matrix. However, the number of openings 132 may be one to eleven or may be thirteen or more. As illustrated in FIG. 2, the first flat diaphragm 100A can be viewed through the openings 132 when the speaker 10A of the present embodiment is viewed from the front side.

As illustrated in FIGS. 3 and 4, the connection member 140A includes a first member 142 and a second member 144. The first member 142 and the second member 144 are made of, for example, resin, metal, wood, or other materials and are elastic bodies with elasticity. The first member 142 is a member formed in a cuboid shape that is hollowed out. The first member 142 is formed such that the inner circumference thereof is larger than the outer circumference of the first flat diaphragm 100A. An adhesive or other adherent substances are used to fix the first member 142 to the second flat diaphragm 130A so that all of the openings 132 fall within the inner circumference of the first member 142. As illustrated in FIGS. 3 and 4, the outer circumferential part of the first flat diaphragm 100A is connected to the inner circumferential surface of the first member 142 through the edge 150A made of cloth, paper, urethane, rubber, or other materials.

As illustrated in FIGS. 3 and 4, the second member 144 is a band-shaped member, and for example, an adhesive or other adherent substances are used to fix the second member 144 to the first member 142. In the present embodiment, the second member 144 is provided between two short sides of the first member 142. However, the second member 144 may be provided between two long sides or may be provided to connect opposite corners of the first member 142. In addition, although the second member 144 is attached to the first member 142 to form the connection member 140A in the present embodiment, the first member 142 and the second member 144 may be integrally molded to form the connection member 140A.

As illustrated in FIG. 4, the actuator 110-1 and the actuator 110-2 are provided on the surface of the second member 144 facing the second flat diaphragm 130A. Note that, when the second member 144 is provided to connect the opposite corners of the first member 142 to form the connection member 140A, the actuators 110-1 and 110-2 can be arranged so that the actuators 110-1 and 110-2 are connected to respective two points on the diagonal line of the first flat diaphragm 100A. Each of the actuators 110-1 and 110-2 is formed in a flat cylindrical shape. Hereinafter, the actuator 110-1 and the actuator 110-2 will be referred to as an “actuator(s) 110” when the actuator 110-1 and the actuator 110-2 do not have to be distinguished from each other. In addition, one of the two surfaces of the actuator 110 that are formed in the circular shape will be referred to as a “first surface,” and the other will be referred to as a “second surface.” Further, a line connecting the center of the first surface and the center of the second surface of the actuator 110 will be referred to as an “axis” of the actuator 110.

Although not illustrated in detail in FIG. 4, the actuator 110 includes a first electrode formed in a disc shape, a piezoelectric material, and a second electrode formed in the same disc shape as the first electrode, which are layered in the axial direction. One of the first electrode and the second electrode is grounded, and a voltage corresponding to a sound signal provided to the speaker 10A is applied to the other. The piezoelectric material between the first electrode and the second electrode expands and contracts in the axial direction of the actuator 110 according to the voltage applied between the first electrode and the second electrode. That is, the actuator 110 expands and contracts according to the provided sound signal.

One of the first surface and the second surface of the actuator 110-1 is connected to the first flat diaphragm 100A through the elastic member 120-1 made of, for example, rubber or other elastic substances. One of the surfaces of the actuator 110-2 is also connected to the first flat diaphragm 100A through the elastic member 120-2 made of, for example, rubber or other elastic substances. Hereinafter, the elastic members 120-1 and 120-2 will be referred to as an “elastic member(s) 120” when the elastic members 120-1 and 120-2 do not have to be distinguished from each other. Once the actuator 110 expands and contracts in the axial direction according to the provided sound signal, the first flat diaphragm 100A vibrates in the axial direction of the actuator 110, and a sound wave corresponding to the sound signal is emitted from both surfaces of the first flat diaphragm 100A. In the sound wave emitted from both surfaces of the first flat diaphragm 100A, the sound wave emitted from the surface on the second flat diaphragm 130A side is emitted to the outer space of the lid body 3 through the opening 132. That is, the elastic member 120 is arranged between the first flat diaphragm 100A and the actuator 110, and the actuator 110 vibrates the first flat diaphragm 100A through the elastic member 120. In addition, the elastic member 120 is directly connected to one of the surfaces of the actuator 110.

The other of the first surface and the second surface of the actuator 110 is fixed to the second member 144 by using, for example, an adhesive or other adherent substances. That is, the connection member 140A is directly connected to the other surface of the actuator 110 to connect the actuator 110 and the second flat diaphragm 130A. Thus, vibration in a phase opposite of that of the vibration applied to the first flat diaphragm 100A is applied from the actuator 110 to the connection member 140A, and the second flat diaphragm 130A vibrates in the axial direction of the actuator 110 according to the vibration. As a result, a sound wave corresponding to the sound signal provided to the actuator 110 is also emitted from the second flat diaphragm 130A toward the outer space of the lid body 3. Note that, as described above, the first flat diaphragm 100A and the second flat diaphragm 130A are arranged parallel to each other, and thus, the first flat diaphragm 100A and the second flat diaphragm 130A both vibrate in the axial direction of the actuator 110, that is, in the same direction.

In the speaker 10A, the sound wave emitted from the first flat diaphragm 100A to the outer space and the sound wave emitted from the second flat diaphragm 130A to the outer space are in opposite phases, and it seems that the sound waves cancel each other out. However, one of or both the mass of the second flat diaphragm 130A and the elasticity of the connection member 140A can be adjusted in the speaker 10A, and the sound pressure in a specific frequency band of the sound wave from the first flat diaphragm 100A can be reinforced by the sound wave from the second flat diaphragm 130A. This can ensure the sound pressure across the usable band from a low frequency range to a high frequency range. The reason is as follows.

In the speaker 10A, a first vibration system includes the first flat diaphragm 100A, the elastic members 120, and the actuators 110, and a second vibration system includes the second flat diaphragm 130A, the connection member 140A, and the actuators 110. The second vibration system is a spring-mass system in which the mass of the second flat diaphragm 130A and the elasticity of the connection member 140A are used as parameters of the vibration system, and the parameters can be adjusted to adjust the frequency response of the second vibration system. Thus, in the speaker 10A, one of or both the mass of the second flat diaphragm 130A and the elasticity of the connection member 140A can be adjusted, and the sound pressure in the specific frequency band of the sound wave from the first flat diaphragm 100A can be reinforced by the sound wave from the second flat diaphragm 130A. This can optionally realize uniform sound pressure frequency characteristics or sound pressure frequency characteristics that reinforce the specific band.

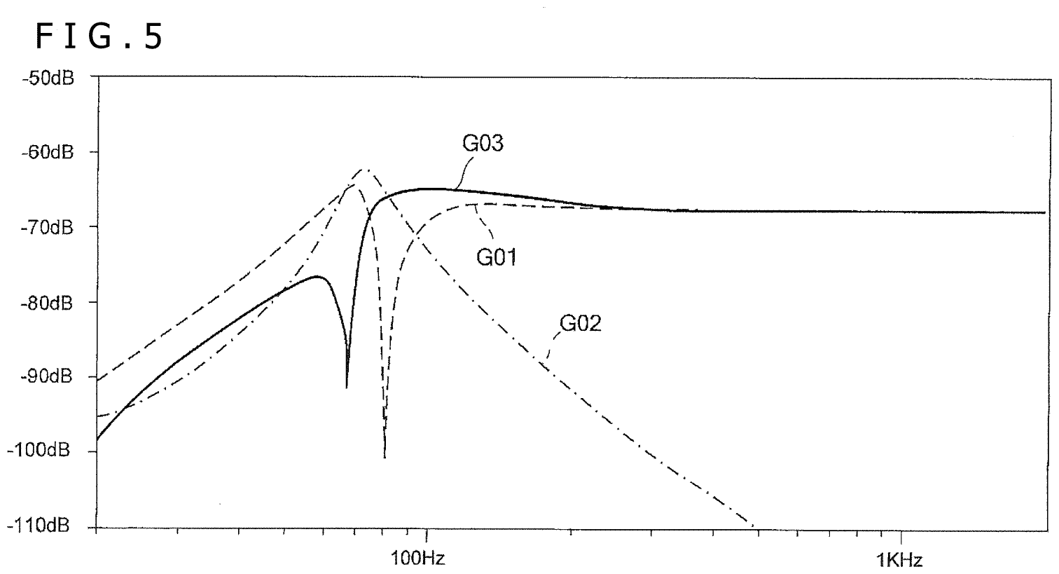

FIG. 5 is a diagram illustrating simulation results regarding the frequency response of the speaker 10A. In FIG. 5, a graph curve G01 drawn with a dotted line is a graph curve of the frequency response of the first vibration system, and a graph curve G02 drawn with an alternate long and short dash line is a graph curve of the frequency response of the second vibration system. In addition, a graph curve G03 drawn with a solid line in FIG. 5 is a graph curve of the frequency response of the entire speaker 10A. As illustrated in FIG. 5, there is a large dip around 80 Hz in the frequency response of the first vibration system. On the other hand, the frequency response of the first vibration system and the frequency response of the second vibration system are combined in the frequency response of the entire speaker 10A, and the dip is shifted to a frequency lower than 70 Hz and is substantially flat in the frequency band equal to or greater than the frequency. Therefore, for example, the lower limit of the usable band of the speaker 10A is extended, and the sound pressure can be ensured across the usable band from a lower frequency range to a high frequency range.

It should be noted here that the speaker 10A according to the present embodiment does not include a bass reflex port or an enclosure. Since the speaker 10A does not include a bass reflex port or an enclosure, the speaker 10A can be thin, and the transportability and the portability of the musical instrument case 1 are not lost even when the speaker 10A is provided on the lid body 3. That is, according to the speaker 10A of the present embodiment, the sound pressure across the usable band from a low frequency range to a high frequency range can be ensured without affecting the transportability and the portability even when a high-volume low tone is necessary.

Note that the advantageous effect of the speaker 10A of the present embodiment is not limited to ensuring the sound pressure across the usable band from a low frequency range to a high frequency range. For example, in a case where the played sound of the musical instrument 4 is detected by a pickup or other apparatuses and the played sound is amplified by an audio amplifier and emitted by the speaker 10A, the second vibration system can reinforce the frequency components corresponding to the body resonance of the musical instrument 4. In this way, the body resonance can be reproduced, and accurate played sound can be emitted to the speaker 10A.

### B: Second Embodiment

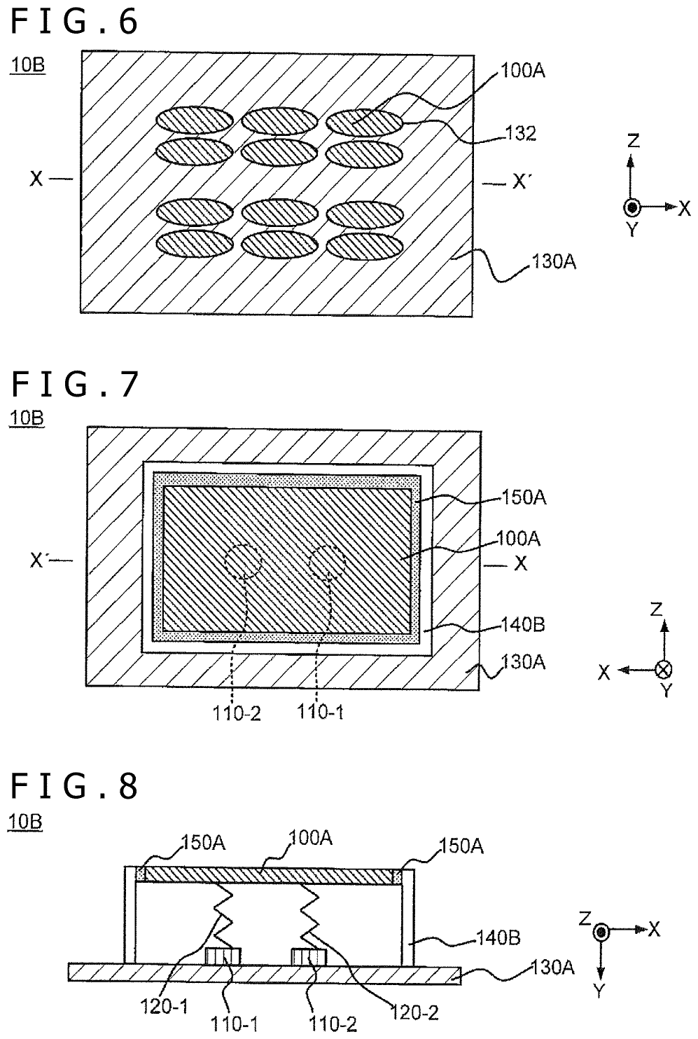

Next, a speaker 10B according to a second embodiment of the present disclosure will be described. The speaker 10B is also a speaker provided on the lid body 3 of the musical instrument case 1, similarly to the speaker 10A. FIGS. 6 to 8 are diagrams illustrating a configuration example of the speaker 10B. More specifically, FIG. 6 is a front view of the speaker 10B, FIG. 7 is a rear view of the speaker 10B, and FIG. 8 is a cross-sectional view of the speaker 10B in a plane along a line XX′ in FIG. 7. In FIGS. 6 to 8, the same reference signs are provided to the same constituent elements as the constituent elements in FIGS. 2 to 4. As is apparent by comparing FIG. 6 and FIG. 2, the speaker 10B includes the first flat diaphragm 100A and the second flat diaphragm 130A, similarly to the speaker 10A. As illustrated in FIG. 8, the first flat diaphragm 100A and the second flat diaphragm 130A are also arranged to face each other in the speaker 10B of the present embodiment as in the speaker 10A of the first embodiment. Note that, also in the second embodiment, the first flat diaphragm 100A is arranged at a position parallel to the second flat diaphragm 130A and separated by a predetermined distance from the second flat diaphragm 130A in the axial direction of the actuator 110. The actuators 110 and the elastic members 120 are arranged between the first flat diaphragm 100A and the second flat diaphragm 130A. In addition, as illustrated in FIG. 6, the plurality of openings 132 are also provided on the part of the second flat diaphragm 130A of the speaker 10B facing the first flat diaphragm 100A. As is apparent by comparing FIG. 7 and FIG. 3 and comparing FIG. 8 and FIG. 4, there are three differences between the configuration of the speaker 10B and the configuration of the speaker 10A as described below.

First, a connection member 140B including only the first member 142 is provided in place of the connection member 140A. Secondly, the actuators 110 and the elastic members 120 are provided in the space between the first flat diaphragm 100A and the second flat diaphragm 130A. Further, thirdly, one of the first surface and the second surface of the actuator 110 is connected to the second flat diaphragm 130A, and the other is directly connected to the first flat diaphragm 100A through the elastic member 120. In the speaker 10B of the present embodiment, part of the second flat diaphragm 130A plays a role of the second member 144 of the speaker 10A. In the speaker 10B of the present embodiment, the second flat diaphragm 130A and the connection member 140B may be integrally molded.

Also in the speaker 10B of the present embodiment, the first vibration system includes the first flat diaphragm 100A, the elastic members 120, and the actuators 110, and the second vibration system includes the second flat diaphragm 130A and the actuators 110. Thus, the same advantageous effect as in the speaker 10A of the first embodiment can also be obtained in the speaker 10B of the present embodiment. Note that, also in the present embodiment, the first flat diaphragm 100A and the second flat diaphragm 130A are arranged parallel to each other, and thus, the first flat diaphragm 100A and the second flat diaphragm 130A both vibrate in the axial direction of the actuator 110, that is, in the same direction.

### C: Third Embodiment

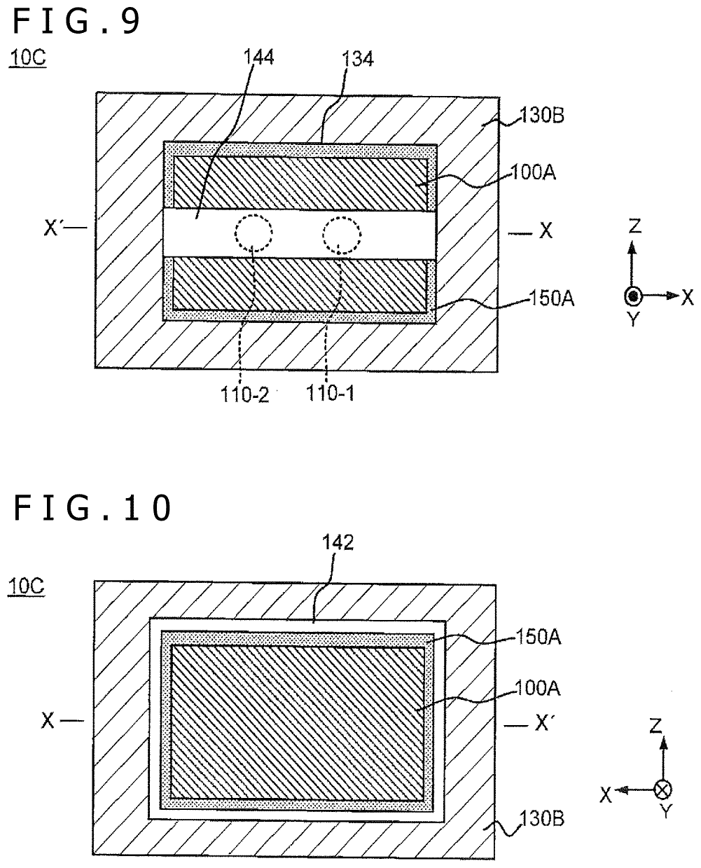

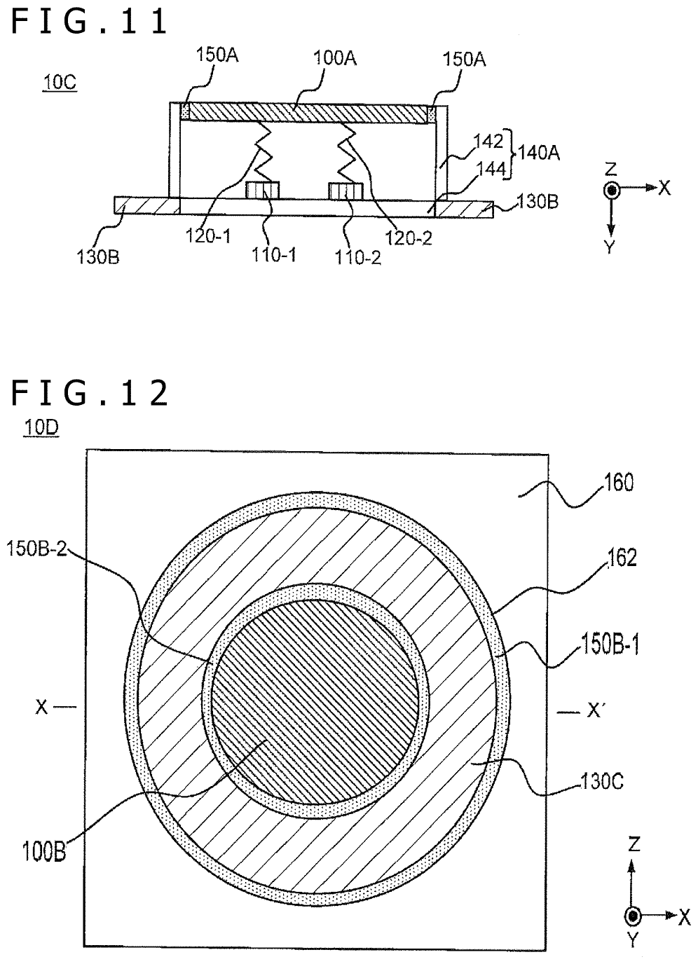

Next, a speaker 10C according to a third embodiment of the present disclosure will be described. The speaker 10C is also a speaker provided on the lid body 3 of the musical instrument case 1, similarly to the speaker 10A. FIGS. 9 to 11 are diagrams illustrating a configuration example of the speaker 10C according to the third embodiment of the present disclosure. More specifically, FIG. 9 is a front view of the speaker 10C, FIG. 10 is a rear view of the speaker 10C, and FIG. 11 is a cross-sectional view of the speaker 10C in a plane along a line XX′ in FIG. 9. In FIGS. 9 to 11, the same reference signs are provided to the same constituent elements as the constituent elements in FIGS. 2 to 4. As is apparent by comparing FIG. 9 and FIG. 2, comparing FIG. 10 and FIG. 3, and comparing FIG. 11 and FIG. 4, there are three differences between the configuration of the speaker 10C and the configuration of the speaker 10A as described below.

First, a second flat diaphragm 130B is provided in place of the second flat diaphragm 130A. The second flat diaphragm 130B is different from the second flat diaphragm 130A in that the second flat diaphragm 130B includes, in place of the plurality of openings 132, only one rectangular opening 134 corresponding to the part surrounded by the inner circumference of the first member 142. Secondly, the connection member 140A is provided on the second flat diaphragm 130B such that the second member 144 of the connection member 140A is positioned on the same plane as the second flat diaphragm 130B. Further, thirdly, the edge 150A and the first flat diaphragm 100A are provided on the opposite side of the side in contact with the second flat diaphragm 130B in the first member 142 as illustrated in FIG. 11. Note that, also in the third embodiment, the first flat diaphragm 100A is arranged at a position parallel to the second flat diaphragm 130B and separated by a predetermined distance from the second flat diaphragm 130B. The actuators 110 and the elastic members 120 are arranged between the first flat diaphragm 100A and the second flat diaphragm 130B.

Also in the speaker 10C of the present embodiment, the first vibration system includes the first flat diaphragm 100A, the elastic members 120, and the actuators 110, and the second vibration system includes the second flat diaphragm 130B, the connection member 140A, and the actuators 110. Thus, the same advantageous effect as in the speaker 10A of the first embodiment can also be obtained in the speaker 10C of the present embodiment. Note that, also in the present embodiment, the first flat diaphragm 100A and the second flat diaphragm 130B are arranged parallel to each other, and thus, the first flat diaphragm 100A and the second flat diaphragm 130B both vibrate in the axial direction of the actuator 110, that is, in the same direction.

### (B: Modifications)

While the embodiments of the present disclosure have been described above, the embodiments may obviously be modified as follows. (1) Although the area of the first flat diaphragm 100A is smaller than the area of the second flat diaphragm 130A in the speaker 10A of the first embodiment, the area of the first flat diaphragm 100A may be equal to the area of the second flat diaphragm 130A. In addition, although the number of actuators 110 is two in the speakers 10A, 10B, and 10C of the embodiments, the number of actuators 110 may be one or may be three or more. Further, although the actuators 110 of the first embodiment are connected to the first flat diaphragm 100A through the elastic members 120, the actuators 110 may be directly connected to the first flat diaphragm 100A.

(2) The actuators 110 in the embodiments may be an electrodynamic type. The electrodynamic actuator includes a base portion including a magnetic circuit and the like; and a vibration portion connected to the base portion through a damper. The vibration portion is arranged on the base portion such that the vibration portion can vibrate in the axial direction. In the case of using the electrodynamic actuator to provide the speaker of the present disclosure, the base portion can be fixed to the second flat diaphragm, and the vibration portion can be fixed to the first flat diaphragm. In this case, the damper functions as an elastic member.

(3) The examples of applying the present disclosure to the speaker provided on the musical instrument case 1 have been described in the embodiments. However, the present disclosure may be applied to a speaker mounted on a portable information terminal, such as a smartphone, a tablet terminal, a portable game console, and a notebook computer. This is because it is similarly preferable that the speaker mounted on the portable information terminal be able to ensure sound pressure across the usable band from a low frequency range to a high frequency range without affecting the transportability and the portability even when a high-volume output is necessary.

In addition, the present disclosure may also be applied to a PA speaker used in such an event as a concert. This is because it is also preferable that the transportability of the PA speaker be high even when a high-volume output is necessary, and it is preferable that the PA speaker be able to ensure sound pressure across the usable band from a low frequency range to a high frequency range. In a word, it is sufficient if a speaker including a first flat diaphragm; an actuator connected to the first flat diaphragm and configured to apply vibration corresponding to a sound signal to the first flat diaphragm; a second flat diaphragm; and an elastic body that connects the actuator and the second flat diaphragm is provided.

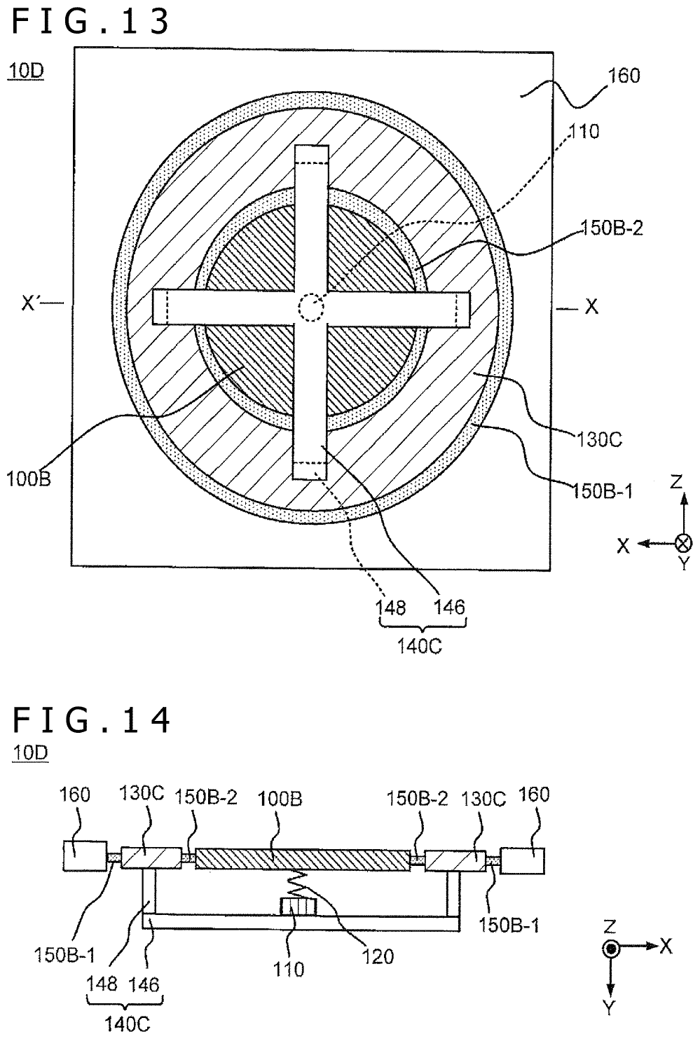

FIGS. 12 to 14 are diagrams illustrating a configuration example of a speaker 10D that is an example of applying the present disclosure to a PA speaker. FIG. 12 is a front view of the speaker 10D, and FIG. 13 is a rear view of the speaker 10D. Further, FIG. 14 is a cross-sectional view of the speaker 10D in a plane along a line XX′ in FIGS. 12 and 13. As illustrated in FIGS. 12 to 14, the speaker 10D includes a front plate 160, edges 150B-1 and 150B-2, a connection member 140C, a second flat diaphragm 130C, the elastic members 120, the actuators 110, and a first flat diaphragm 100B.

As illustrated in FIGS. 12 to 14, a circular opening 162 is provided on the front plate 160, and the edge 150B-1 formed in an annular shape is provided along the inner circumference of the opening 162. The outer circumference of the second flat diaphragm 130C formed in an annular shape is connected to the inner circumference of the edge 150B-1, and the outer circumference of the edge 150B-2 formed in an annular shape is connected to the inner circumference of the second flat diaphragm 130C. Further, the outer circumference of the first flat diaphragm 100B formed in a disc shape is connected to the inner circumference of the edge 150B-2. As illustrated in FIG. 14, the first flat diaphragm 100B and the second flat diaphragm 130C are arranged on the same plane in the speaker 10D. Note that, in the present configuration example, the first flat diaphragm 100B is arranged at a position separated by a predetermined distance from the second flat diaphragm 130C in the direction parallel to the second flat diaphragm 130C. In addition, the edge 150B-2 is arranged between the first flat diaphragm 100B and the second flat diaphragm 130C.

The connection member 140C includes a first member 146 provided in a cross shape and four second members 148 formed in a cuboid shape. Each of the four second members 148 is provided on each of four edges of the first member 146, and the second members 148 are fixed to the second flat diaphragm 130C so that the center of the first member 146 and the center of the first flat diaphragm 100B overlap with each other. One of the first surface and the second surface of the actuator 110 is connected to the surface of the first member 146 facing the first flat diaphragm 100B, and the other surface of the actuator 110 is connected to the first flat diaphragm 100B through the elastic member 120. Note that the shape of the first member 146 is not limited to the cross shape, and the shape may be a three-pronged shape or a six-pronged shape. When a member with a three-pronged shape is used as the first member 146, the second member 148 can be provided on each of three edges of the first member 146 to form the connection member 140C. In addition, when a member with a six-pronged shape is used as the first member 146, the second member 148 can be provided on each of six edges of the first member 146 to form the connection member 140C.

In the speaker 10D illustrated in FIGS. 12 to 14, the first vibration system includes the first flat diaphragm 100B, the elastic members 120, and the actuators 110, and the second vibration system includes the second flat diaphragm 130C, the connection member 140C, and the actuators 110. Thus, the same advantageous effect as in the speakers of the embodiments described above can also be obtained in the speaker 10D of the present modification example. Note that, in the present configuration example, the first flat diaphragm 100B and the second flat diaphragm 130C are arranged on the same plane, and thus, the first flat diaphragm 100B and the second flat diaphragm 130C both vibrate in the axial direction of the actuator 110, that is, in the same direction.

It should be understood by those skilled in the art that various modifications, combinations, sub-combinations and alterations may occur depending on design requirements and other factors insofar as they are within the scope of the appended claims or the equivalent thereof.

1. A speaker comprising:
a first flat diaphragm;
a second flat diaphragm;
an actuator that applies vibration corresponding to a sound signal to the first flat diaphragm; and an elastic body that connects the actuator and the second flat diaphragm.

2. The speaker according to claim 1, wherein
an area of the first flat diaphragm is smaller than an area of the second flat diaphragm.

3. The speaker according to claim 1, wherein
the elastic body and the second flat diaphragm are integrally molded.

4. The speaker according to claim 1, wherein
the first flat diaphragm and the second flat diaphragm are arranged to face each other.

5. The speaker according to claim 1, wherein
the first flat diaphragm and the second flat diaphragm are arranged parallel to each other.

6. The speaker according to claim 1, wherein
the first flat diaphragm and the second flat diaphragm are arranged on a same plane.

7. The speaker according to claim 1, further comprising:
an elastic member arranged between the first flat diaphragm and the actuator, wherein
the actuator applies the vibration to the first flat diaphragm through the elastic member.

8. The speaker according to claim 1, wherein
the actuator applies, to the second flat diaphragm, vibration in a phase opposite of that of the vibration applied from the actuator to the first flat diaphragm.

9. The speaker according to claim 1, wherein
the actuator has a shape including a first surface and a second surface,
the first flat diaphragm is connected to the first surface of the actuator, and
the second flat diaphragm is connected to the second surface of the actuator.

10. The speaker according to claim 8, wherein
the elastic member is directly connected to the first surface of the actuator.

11. The speaker according to claim 10, wherein
the elastic body is directly connected to the second surface of the actuator.

12. The speaker according to claim 10, wherein
the second surface of the actuator is directly connected to the second flat diaphragm.

13. A musical instrument case comprising:
a case main body that houses a musical instrument;
a lid body; and
the speaker according to claim 1, wherein
the lid body provides the second flat diaphragm.
